(19) United States
(12) Patent Application Publication
(10) Pub. No.: US 2006/0245177 A1
(43) Pub. Date: Nov. 2, 2006

(54) Decorative tree

(76) Inventor: George Tsai, Taipei (TW)

Correspondence Address: PATENTTM.US, P. O. BOX 82788, PORTLAND, OR, 97282-0788, US

(21) Appl. No.: 11/121,459

(22) Filed: May 2, 2005

(51) Int. Cl. F21S 6/00

(52) U.S. Cl. 362/123

(57) ABSTRACT

A decorative tree has a branch assembly and multiple light strings. The branch assembly has a bottom pole, at least one top pole, multiple branches and multiple outer rings. The poles are attached to each other. The branches are attached pivotally to each pole. The outer rings are attached to the branches respectively on the poles. The light strings are attached securely to the outer rings to form a tree-form decorative tree.

### BACKGROUND OF THE INVENTION

1. Field of the Invention

The present invention relates to decorative tree, especially to a decorative tree that occupies a small volume when stowed.

2. Description of the Prior Arts

Decorative trees are used as decorations especially during the Christmas season in homes, department stores, shopping malls and expositions. The decorative trees are usually used only for a limited period of time. A conventional decorative tree comprises a body and multiple light bulbs. The body is usually a real tree that cannot be taken apart or an artificial tree that is not easy to be taken apart. The real tree and the artificial tree both have multiple branches. The light bulbs are hung on the branches. Because the decorative tree is used only for a limited period of time, the decorative tree has to be stowed when the decorative tree is not used. If the body is a real tree, the branches of the real tree cannot be removed. If the body is an artificial tree, the branches of the artificial tree are not easy to be removed. Therefore, the branches of the real trees occupy a large volume when the decorative tree is stowed. Even when the artificial tree is taken apart, the components of the artificial tree still occupies a large volume.

To overcome the shortcomings, the present invention provides a decorative tree that occupies a small volume when stowed and can be taken apart easily to mitigate or obviate the aforementioned problems.

### SUMMARY OF THE INVENTION

The main objective of the present invention is to provide a decorative tree that occupies a small volume when the decorative tree is stowed and can be taken apart easily. The decorative tree has a branch assembly and multiple light strings. The branch assembly has a bottom pole, at least one top pole, multiple branches and multiple outer rings. The poles are attached to each other. The branches are attached pivotally to each pole. The outer rings are attached to the branches respectively on the poles. The light strings are attached securely to the outer rings to form a tree-shaped decorative tree.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a decorative tree in accordance with the present invention;

FIG. 2 is an exploded perspective view of the decorative tree in FIG. 1 without light strings;

FIG. 3 is a perspective view of a central pole of the decorative tree in FIG. 1;

FIG. 4 is an operational perspective view of the central pole in FIG. 3;

FIG. 5 is an exploded perspective view of an outer ring of the decorative tree in FIG. 1;

FIG. 6 is a perspective view of the outer ring and light strings of the decorative tree in FIG. 1; and

FIG. 7 is a partial side view of the light string of the decorative tree in FIG. 1 with hooks;

FIG. 8 is a partial side view of the light string of the decorative tree in FIG. 1 with an adhesive strap; and

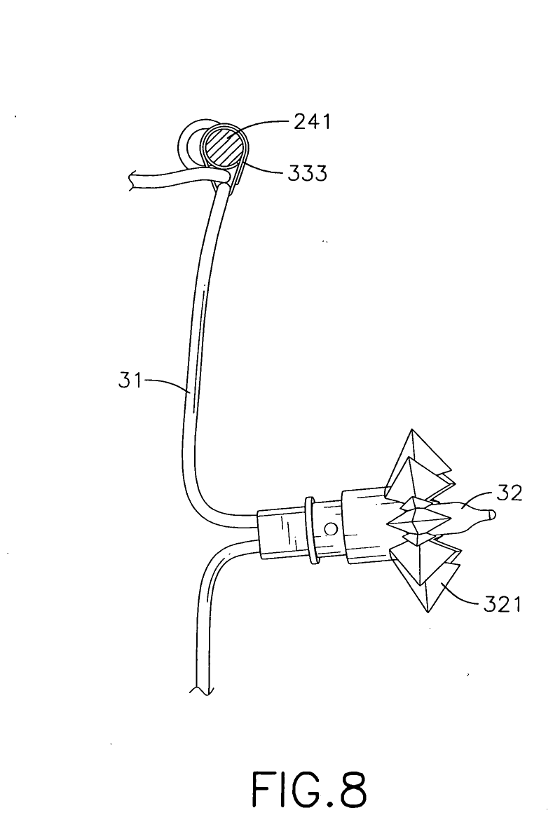

FIG. 9 is a partial side view of the light string of the decorative tree in FIG. 1 with a strip.

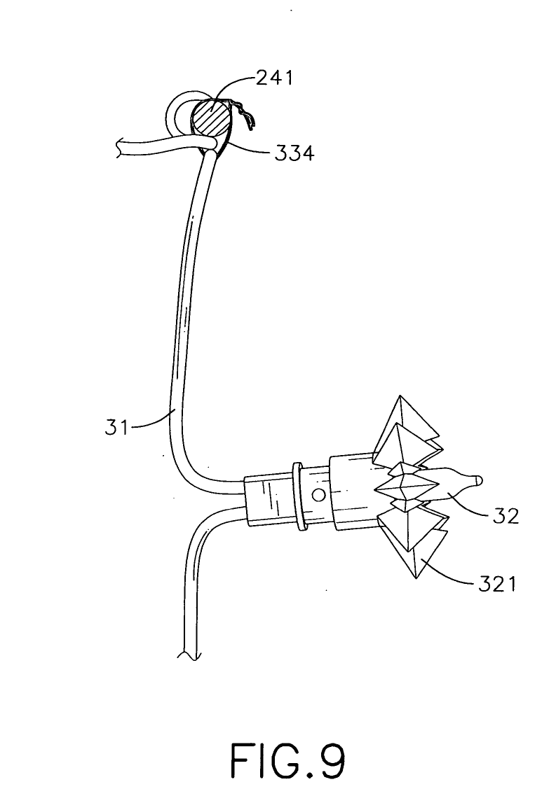

### DETAILED DESCRIPTION OF THE PREFERRED EMBODIMENTS

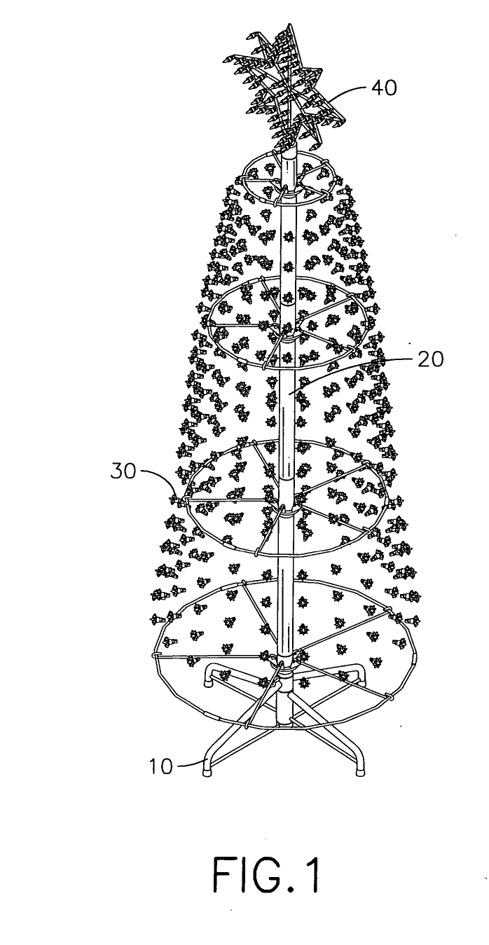

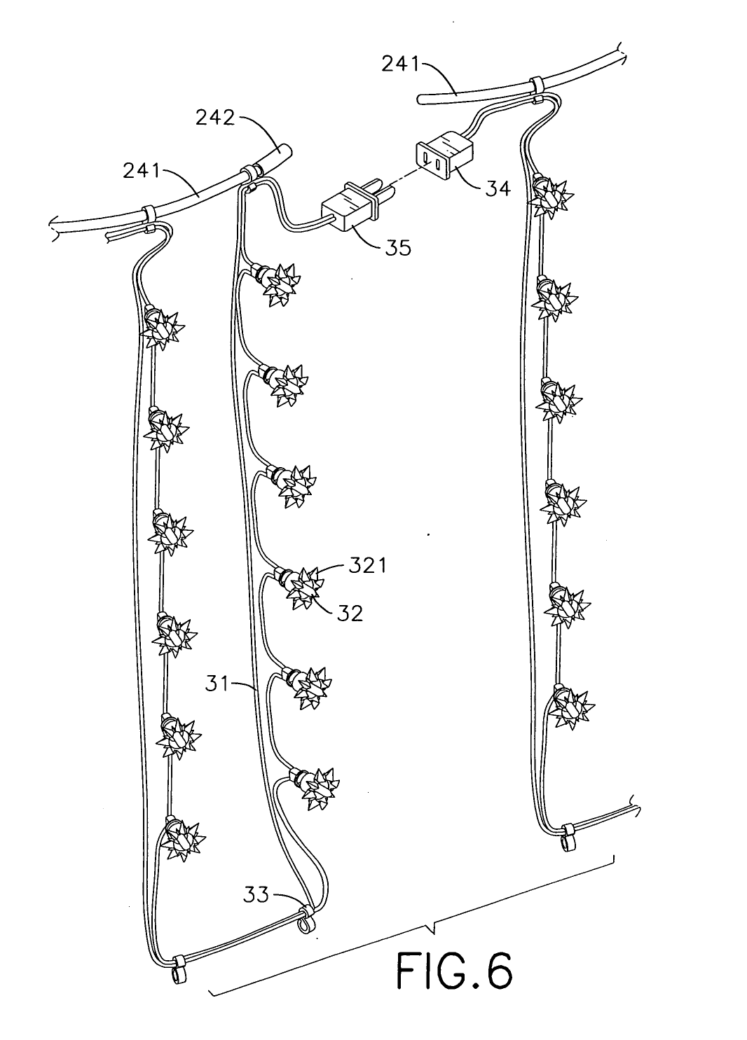

With reference to FIGS. 1 and 6, a decorative tree in accordance with the present invention comprises an optional base (10), a branch assembly (20), at least one light string (30), multiple fasteners (33) and an optional tree-crown (40).

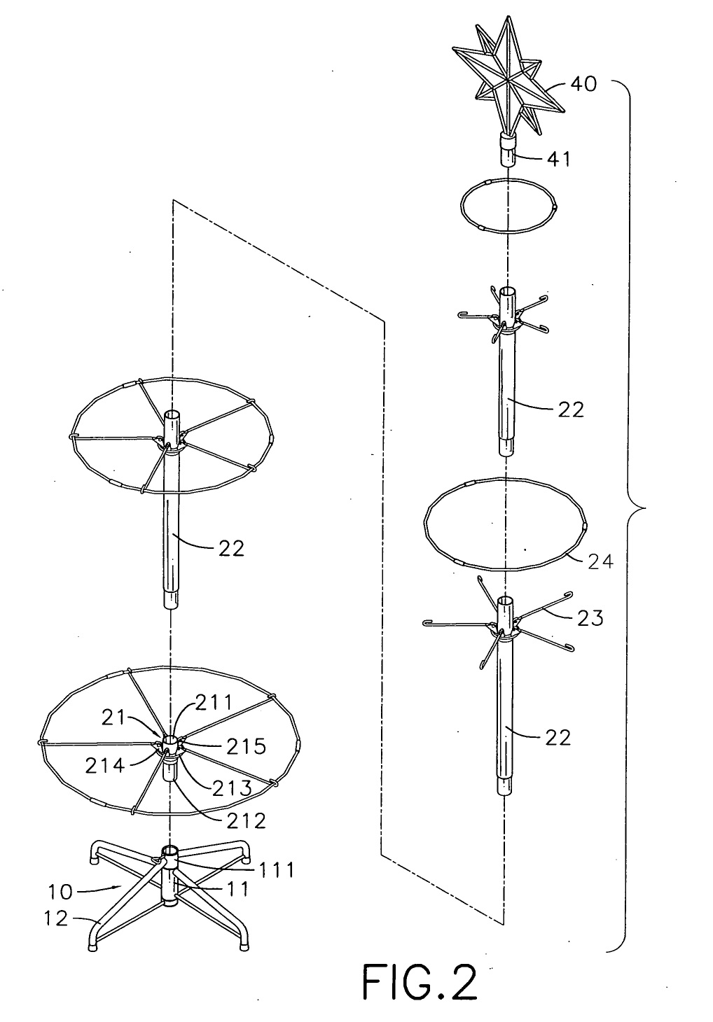

With further reference to FIG. 2, the base (10) has a central support (11) and multiple legs (12). The central support (11) has an outer wall, an upper end, and a connector (111). The connector may be a sleeve or a post. The legs (12) are attached separately to the outer wall of the central support (11).

The branch assembly (20) is mounted on the ground, a floor or a base panel or is mounted on the base (10) and has a bottom pole (21), at least one top pole (22), multiple branches (23) and multiple outer rings (24).

The bottom pole (21) is mounted on the ground, a floor or a base panel or is mounted on the base (10) and has a lower end, an upper end, a lower connector (212), an outer wall, an upper connector (211) and multiple optional brackets (213). The lower connector (212) is-formed on the lower end of the bottom pole (21), connects to the connector (111) on the base (10) and is a sleeve when the connector (111) on the base (10) is a post or is a post when the connector (111) on the base (10) is a sleeve. The upper connector (211) is formed on the upper end of the bottom pole (21), is the complement of the lower connector (212), is a sleeve or a post and is a post when the lower connector (212) is a sleeve or is a sleeve when the lower connector (212) is a post. The brackets (213) are attached to and protrude out from the outer wall of the bottom pole (21), and each bracket (213) has a pivot pin hole (215) and at least one wing (214) with the pivot hole (215) formed through the at least one wing (214). When the bracket (213) has two wings (214), the wings (214) are parallel, and the pivot pin hole (215) is formed through both wings (214).

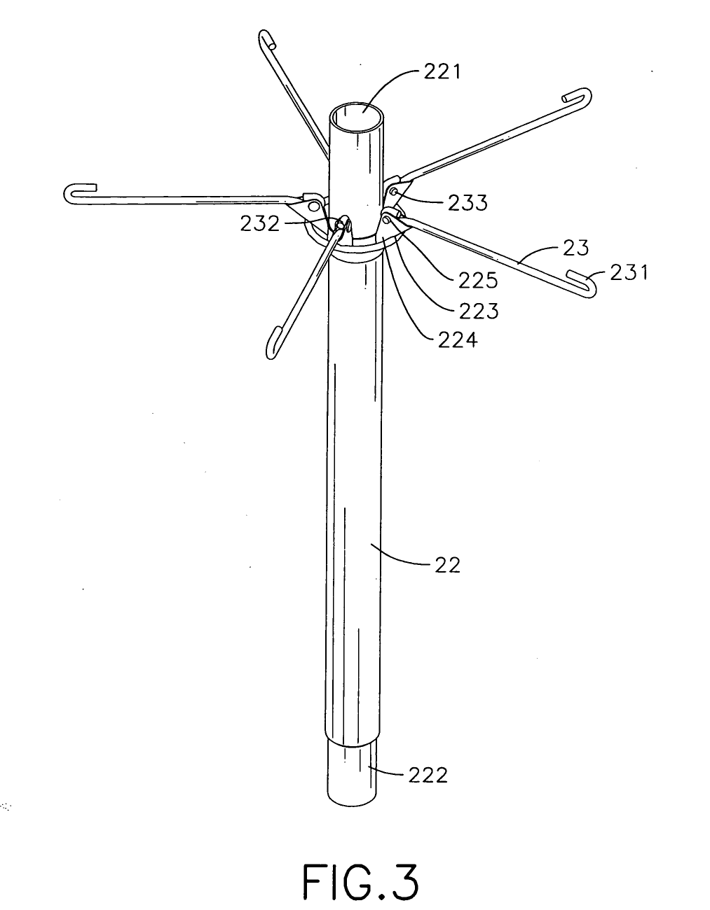

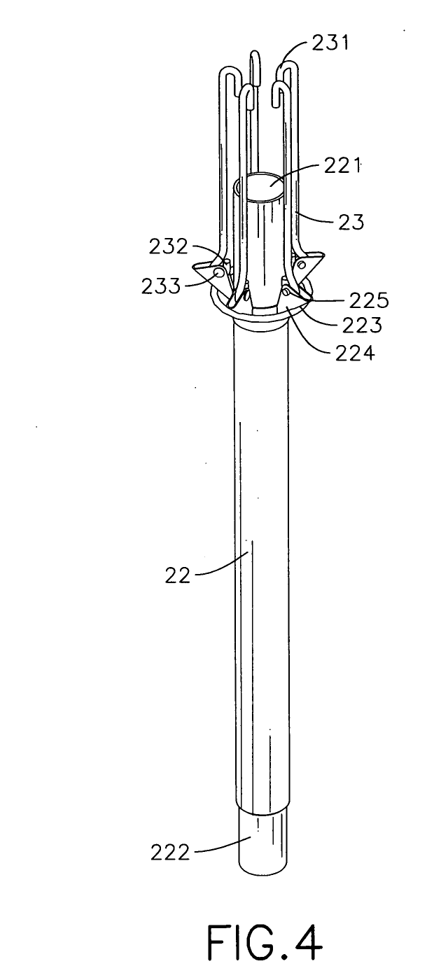

With further reference to FIGS. 3 and 4, at least one top pole (22) is mounted on the bottom pole (21), and each top pole (22) has an upper end, a lower end, an upper connector (221), an outer wall, a lower connector (222) and multiple optional brackets (223). The upper connector (221) is formed on the upper end of the top pole (22), is the same as the upper connector (211) on the bottom pole (21) and may be a sleeve or a post. The lower connector (222) is formed on the lower end of the top pole (22), is the same as the lower connector (212) on the bottom pole (21), is a sleeve when the upper connector (211) on the bottom pole (21) is a post, is a post when the upper connector (211) on the bottom pole (21) is a sleeve and attaches to the upper connector (211) on the bottom pole (21) or the upper connector (221) on an adjacent top pole (22). The brackets (223) are formed on the outer wall of the top pole (22), and each bracket (223) has a pivot pin hole (225) and may have two wings (224) or one wing. The brackets (223) have the same structure as the brackets (213) on the bottom pole (21) so redundant description has not been included.

Branches (23) are mounted pivotally on the outer wall of each pole (21, 22). Each branch (23) has a distal end, a proximal end, an optional outer hook (231), an optional inner eye (232) and an optional pivot pin (233). The branches (23) mounted on higher top poles (22) are shorter than the branches (23) mounted on lower poles (21, 22) of the decorative tree. The outer hook (231) is formed on the distal end of the branch (23). The inner eye (232) is formed on the proximal end of the branch (23). The pivot pin (233) extends through the inner eye (232) on the proximal end of the branch (23) and the pivot holes (215, 225) in the wings (214, 224) to attach the branch (23) pivotally to the poles (21, 22).

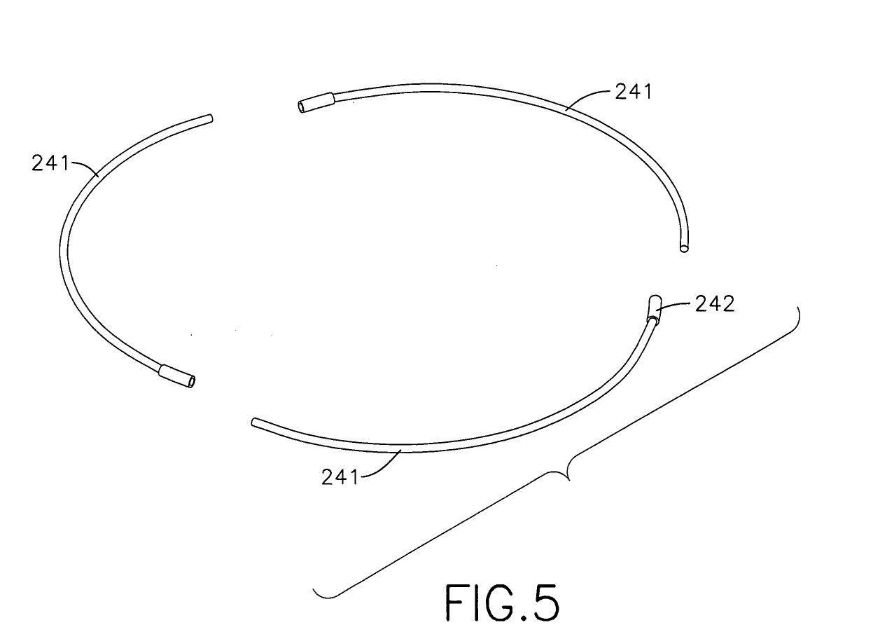

The outer rings (24) are attached to the distal ends of the branches (23), and may be hooked by the outer hooks (231) on the branches (23). With further reference to FIG. 5, each outer ring (24) is smaller than the adjacent lower outer ring (24), may be circular, triangular or square and may have multiple segments (241). The segments (241) connect to each other, and each segment (241) has two ends and a ring connector (242). The ring connectors (242) is attached to one end of each segment (241) and connect to the end of an adjacent segment (241).

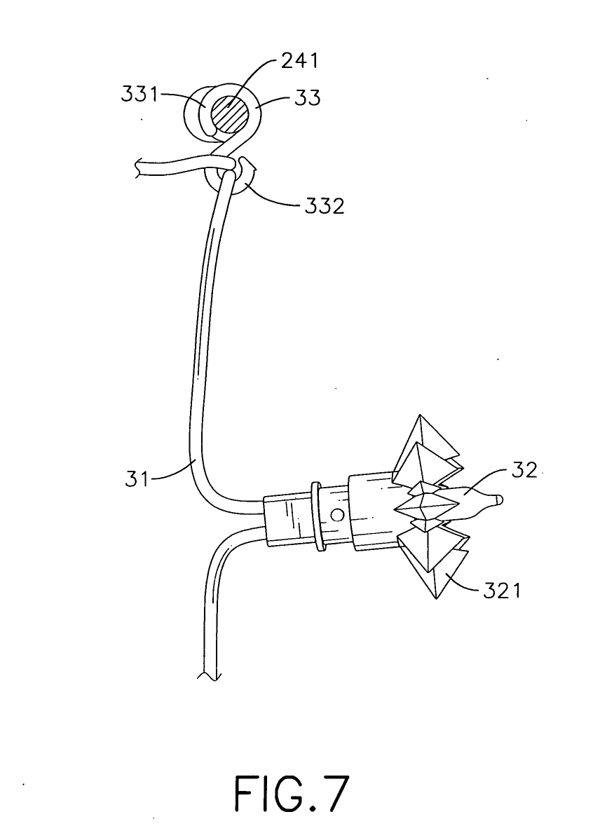

With further reference to FIGS. 6 and 7, the fasteners (33) are attached to the outer rings (24), and each fastener (33) may have a proximal end, a distal end and may have an inner hook (331) and an outer hook (332), may be an adhesive strap (333) or may be a strip (334). The hooks (331, 332) are formed respectively on the ends of the fastener (33) and may be open eyes. The inner hooks (331) clamps the outer ring (24) to attach the fastener (30) securely to the outer ring (24). The adhesive strap (333) is attached to the outer ring (24). The strip (334) is attached to the outer ring (24).

The at least one light string (30) is mounted securely on the outer rings (24). Each light string (30) has multiple wires (31), multiple bulbs (32), a plug (35) and an optional socket (34). The bulbs (32) are mounted on and electrically connected to the wires (31), and each bulb (32) may have a decorative shell (321). The wires (31) are mounted through the fasteners (33) to attach the wires (31) to the segments (241) of the outer rings (24). The plug (35) electrically connects to the wires (31) to provide electricity to the bulbs (32) when the plug (35) connected to a source of electricity. The socket (34) electrically connects to the wires (31) to provide electricity to an adjacent light string (30) when the plug (35) on the adjacent light string (30) is plugged into the socket (34).

The tree-crown (40) is attached to the uppermost top pole (22) and has a connector (41). The connector (41) is formed on the tree-crown (40), is the complement of the upper connector (221) on the top poles (22) and is connected to the upper connector (221) on the uppermost top pole (22).

The decorative tree as described has numerous advantages. Because the poles (21, 22) and the outer rings (24) can be taken apart and the branches (23) can be pivoted, the decorative tree only occupies a small volume when the decorative tree is stowed. Because the light strings (30) are mounted on the outer rings (24) to form a tree-shaped decorative tree, the decorative tree does not need to have many branches (23) and still provides the distinct impression of being a tree. Using fewer branches can reduce the cost and decrease the volume when the decorative tree is stowed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A decorative tree comprising
a branch assembly having
a bottom pole having
a lower end;
an upper end;
a lower connector formed the lower end of the bottom pole; and
an outer wall; and
an upper connector formed on the upper end of the bottom pole;
at least one top pole, one of the at least one top poles attached to the bottom pole, and each one of the at least one top pole having an upper end;
a lower end;
an upper connector formed on the upper end of the top pole;
an outer wall; and
a lower connector formed on the lower end of the top pole to connect with the upper connector on one of the bottom pole and a lower top pole;
multiple branches mounted pivotally on the outer wall of each pole, branches mounted on a higher pole being shorter than branches mounted on a lower pole, and each branch having
a distal end; and
a proximal end; and
multiple outer rings attached to the distal ends of the branches, and each outer ring being smaller than the an adjacent lower outer ring; and
multiple fasteners attached to the outer rings; and
at least one light string mounted securely on the outer rings with the fasteners, and each light string having
multiple wires mounted through the fasteners to attach the wires to the outer rings; and
multiple bulbs mounted on and electrically connected to the wires; and
a plug electrically to the wires to provide electricity to the bulbs when the plug is connect to a source of electricity.

2. The decorative tree as claimed in claim 1, wherein
the decorative tree further comprises a base having
a central support having
an outer wall;
an upper end; and
a connector;
multiple legs attached separately to the outer wall of the central part;
the branch assembly is mounted on the base;
the bottom pole is mounted on the base; and
the lower connector on the bottom pole connects to the connector on the base.

3. The decorative tree as claimed in claim 2, wherein
the connector on the central support of the base is a sleeve;
the lower connector on the bottom pole is a post; and
the upper connector on each one of the at least one top pole is a sleeve; and
the lower connector on each one of the at least one top pole is a post.

4. The decorative tree as claimed in claim 1, wherein each outer ring has multiple segments connecting to each other, and each segment has
two ends; and
a ring connector attached to one end, and connected to one end of an adjacent segment.

5. The decorative tree as claimed in claim 3, wherein each outer ring has multiple segments connecting to each other, and each segment has
two ends; and
a ring connector attached to one end, and connected to one end of an adjacent segment.

6. The decorative tree as claimed in claim 5, wherein
each branch further has
an outer hook formed on the distal end of the branch; and
an inner eye formed on the proximal end of the branch;
the outer rings are hooked by the outer hooks on the branches; and
each fastener of the light string has
a proximal end;
a distal end;
an inner hook formed on the proximal end of the fastener and clamping a corresponding outer ring to attach the fastener secure to the outer ring; and
an outer hook formed on the distal end of the fastener and attaching the wires of the light string to the corresponding outer ring.

7. The decorative tree as claimed in claim 5, wherein
each branch further has
an outer hook formed on the distal end of the branch; and
an inner eye formed on the proximal end of the branch;
the outer rings are hooked by the outer hooks on the branches; and
each fastener of the light string being an adhesive strap attached to the corresponding outer ring.

8. The decorative tree as claimed in claim 5, wherein
each branch further has
an outer hook formed on the distal end of the branch; and
an inner eye formed on the proximal end of the branch;
the outer rings are hooked by the outer hooks on the branches; and
each fastener of the light string being a strip attached to the corresponding outer ring.

9. The decorative tree as claimed in claim 6, wherein
each of the bottom pole and the at least one top pole has multiple brackets attached to and protruding from the outer wall, and each bracket has
at least one wing; and
a pivot hole formed through the at least one wing; and
each branch has a pivoting pin extending through the inner eye on the proximal end of the branch and the pivot hole in corresponding at least one wing to attach the branch pivotally to the poles.

10. The decorative tree as claimed in claim 1 further comprising a tree-crown attached to an uppermost one of the at least one top pole and having a connector formed on the tree-crown and connected to the upper connector on the uppermost pole.

11. The decorative tree as claimed in claim 9 further comprising a tree-crown attached to an uppermost one of the at least one top pole and having a connector formed on the tree-crown and connected to the upper connector on the uppermost pole.

12. The decorative tree as claimed in claim 1, wherein each light string has a socket electrically connected to the wires to provide electricity to an adjacent light string when the plug on the adjacent light string is plugged into the socket.

13. The decorative tree as claimed in claim 11, wherein each light string has a socket electrically connected to the wires to provide electricity to an adjacent light string when the plug on the adjacent light string is plugged into the socket.

14. The decorative tree as claimed in claim 1, wherein the outer rings are circular.

15. The decorative tree as claimed in claim 13, wherein the outer rings are circular.

16. The decorative tree as claimed in claim 1, wherein each bulb on the at least one light string has a decorative shell.

17. The decorative tree as claimed in claim 15, wherein each bulb on the at least one light string has a decorative shell.
